(19) United States
(12) Patent Application Publication
(10) Pub. No.: US 2006/0288077 A1
(43) Pub. Date: Dec. 21, 2006

(54) Systems and methods for instant messaging

(75) Inventor: Chia-Hung Chen, Lujhou City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/319,838

(22) Filed: Dec. 28, 2005

Related U.S. Application Data
(60) Provisional application No. 60/691,063, filed on Jun. 16, 2005.

(51) Int. Cl. G06F 15/16

(52) U.S. Cl. 709/206

(57) ABSTRACT

An instant messaging system comprising a server and a client device. The server provides an instant messaging service and stores a master contact list, wherein the master contact list specifies the latest presence status of a plurality of buddy names predetermined by users. The client device utilizes the instant messaging service provided by the server. The client device comprises a storage device and a processor. The storage device stores a local slave contact list previously duplicated from the master contact list. The processor performs a login process to the server, causes the local slave contact list to be displayed, and duplicates the master contact list to update the local slave contact list and generates a new contact list therefrom transparently.

### CROSS REFERENCE TO RELATED APPILCATIONS

This application claims the benefit of U.S. Provisional Application No. 60/691,063, filed Jun. 16, 2005.

### BACKGROUND

The invention relates to instant messaging and in particular to a method of providing an instant messaging service.

Instant messaging (IM) systems have become popular recently. A common characteristic of most IM systems is that a client user can set up a network of friends or colleagues, more commonly known as “buddies” and exchange messages instantly. Most IM services offer a “presence awareness” feature, indicating whether buddies specified in a contact list are currently online and available to chat. The contact list may be referred to as a ‘Buddy List’.

Generally, a login procedure must be performed before initiating an instant messaging session. Two conventional methods are used for performing a login procedure.

Using FIG. 1 as an example, an operation of login procedure according to a conventional instant messaging service is illustrated. An instant message client 11 (hereinafter referred to as client 11) initiates a login procedure in conjunction with a server 15. A login request 111 is first sent from client 11 to server 15, and a login response 151 is sent from server 15 to client 11. A (group) contact list request 112 is then sent from client 11 to server 15, and a (group) contact list response 152 is sent from server 15 to client 11. A request 113 for detailed information of each group is sent from client 11 to server 15, and detailed information of each group 153 is sent from server 15 to client 11. A request 114 for detailed information of each contact buddy name is sent from client 11 to server 15, and detailed information of each buddy name 154 is sent from server 15 to client 11. Locally stored data is then updated using the received information (step S115). The updated locally stored data is then presented and the instant messaging function is enabled (step S117).

The method depicted in FIG. 1 for initiating an instant message session is time-consuming. The situation deteriorates when a long contact list is transmitted over a narrow-bandwidth communication connection.

Using FIG. 2 as an example, a login procedure according to another conventional instant messaging service is illustrated. An instant message client 21 (hereinafter referred to as client 21) initiates a login procedure in conjunction with a server 25. A login request 211 is first sent from client 21 to server 25, and a login response 251 is sent from server 25 to client 21. A locally stored contact list is displayed (step S213). Here, the contact list presented in step S213 is stored in client 21, which may be a contact list used in a previous instant message application. The presence status of each buddy name of the presented contact list may be different from a current presence status saved in server 25.

According to the method depicted in FIG. 2, a user can initiate an instant message session using a local-v stored contact list without updating status of buddy names of the contact list. As the contact list has not yet been updated, the status of the buddy names in the contact list may not be accurate. Additionally, when a user performs the login procedure to initiate an instant message session in a client device where a contact list is not locally available, a contact list must first be downloaded from server 25. According to this method, the presence status of buddy names in the contact list saved in client 21 is updated passively by server 25.

### SUMMARY

The present invention provides an instant messaging system comprising a server and a client device. The server provides an instant messaging service and stores a master contact list, wherein the master contact list includes at least one name. The client device utilizes the instant messaging service, comprising a storage device and a processor. The storage device stores a local slave contact list. The processor performs a login process to the server; retrieves the local slave contact list from the storage device, wherein the local slave contact list includes at least one name; enables the instant message service right after the login process; and updates initialization information corresponding to each name listed in the local slave contact list transparently according to the master contact list stored in the server.

Also provided is a device utilizing an instant messaging service provided by a server. The device comprises a storage device and a processor. The storage device stores a local slave contact list. The processor performs a login process to the server; retrieves the local slave contact list from the local storage device, wherein the local slave contact list includes at least one name; enables the instant message service right after the login process; and updates initialization information corresponding to each name listed in the local slave contact list transparently according to a master contact list stored in the server.

Also provided is a method for utilizing an instant messaging service provided by a server. A login process to the server is performed. A local slave contact list stored in a local storage device is retrieved, wherein the local slave contact list includes at least one name. The instant message service is enabled right after the login process. Initialization information corresponding to each name listed in the local slave contact list is updated transparently according to a master contact list stored in the server.

### DESCRIPTION OF THE DRAWINGS

The invention can be more fully understood by reading the subsequent detailed description and examples with references made to the accompanying drawings, wherein:

FIG. 1 illustrates a login procedure according to a conventional instant messaging service;

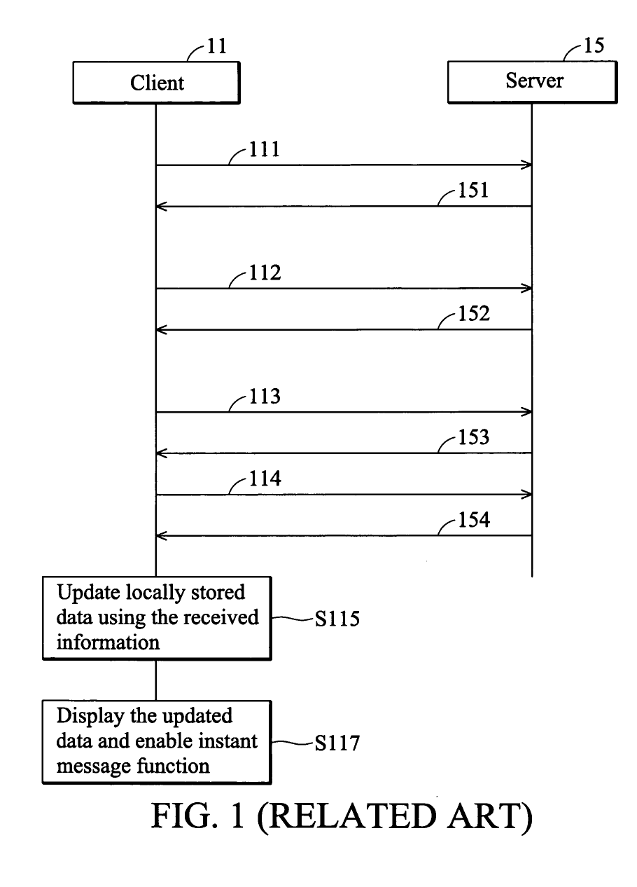

FIG. 2 illustrates a login procedure according to another conventional instant messaging service;

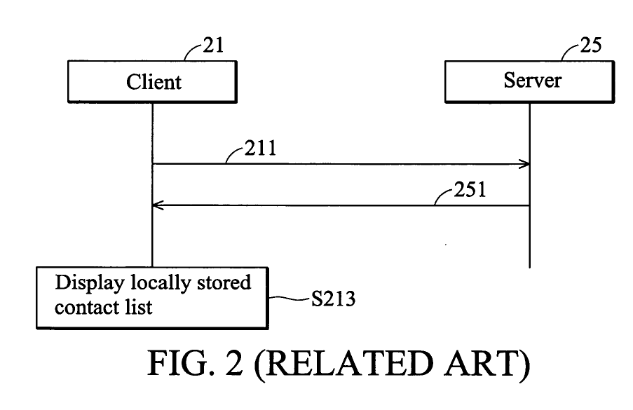

FIG. 3 shows a schematic view of an embodiment of an instant messaging system;

FIG. 4 is a schematic diagram of an embodiment of a communication system providing a PoC service;

FIG. 5 shows operations of an embodiment of a method for an instant messaging application; and

FIGS. 6A and 6B illustrate an embodiment of a contact list displayed on a screen of client device.

### DETAILED DESCRIPTION

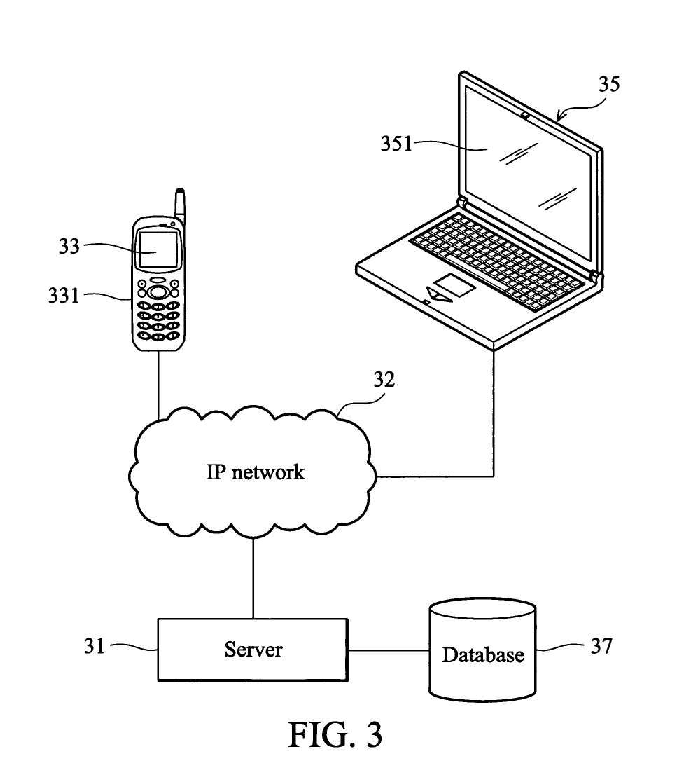

The invention will now be described with reference to FIGS. 3 through 6, which generally relate to an instant messaging system. It is understood that instant messaging services transmitting visual or audio instant messages may be implemented.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

FIG. 3 shows a schematic view of an embodiment of an instant messaging system. A server 31 provides an instant messaging service to a mobile phone 33 and a client computer 35 via an IP network 32. The server 31 operates with a database 37 storing a master contact list for a user. The master contact list specifies the latest presence status of a plurality of buddy names predetermined by the user.

The mobile phone 33 comprises a storage device (not shown) storing a local slave contact list duplicated from the master contact list. The local slave contact list specifies the presence status of a plurality of buddy names-predetermined by the user. The mobile phone 33 comprises a processor (not shown) and a screen 331. The processor performs a login process to server 31, causes screen 331 to display the local slave contact list. The screen 331 may display the local slave contact list immediately after the login process. Screen 331 further displays an icon for each buddy name within the local slave contact list. Initially, buddy names in the local slave contact list are displayed with a ‘blurred icon’. The initialization information corresponding to each name listed in the local slave contact list is then updated transparently. After the initiation information is updated, the corresponding icon is changed from the ‘blurred appearance’ to a ‘clear appearance’ The processor can send and receive an instant message before the new contact list is generated. The instant message may comprise visual information, such as text and graphics. When the client computer 35 is used for an instant messaging service, the client computer 35 comprises a storage device (not shown) storing a local slave contact list duplicated from the master contact list. The local slave contact list specifies the presence status of a plurality of buddies predetermined by the user. The client computer 35 comprises a processor (not shown) and a screen 351. The processor performs a login process to server 31, causes screen 351 to display the local slave contact list. The screen 351 may display the local slave contact list immediately after the login process. Screen 351 further displays an icon for each buddy name within the local slave contact list. The processor can send and receive an instant message before the new contact list is generated. The instant message may comprise visual information, such as text and graphics.

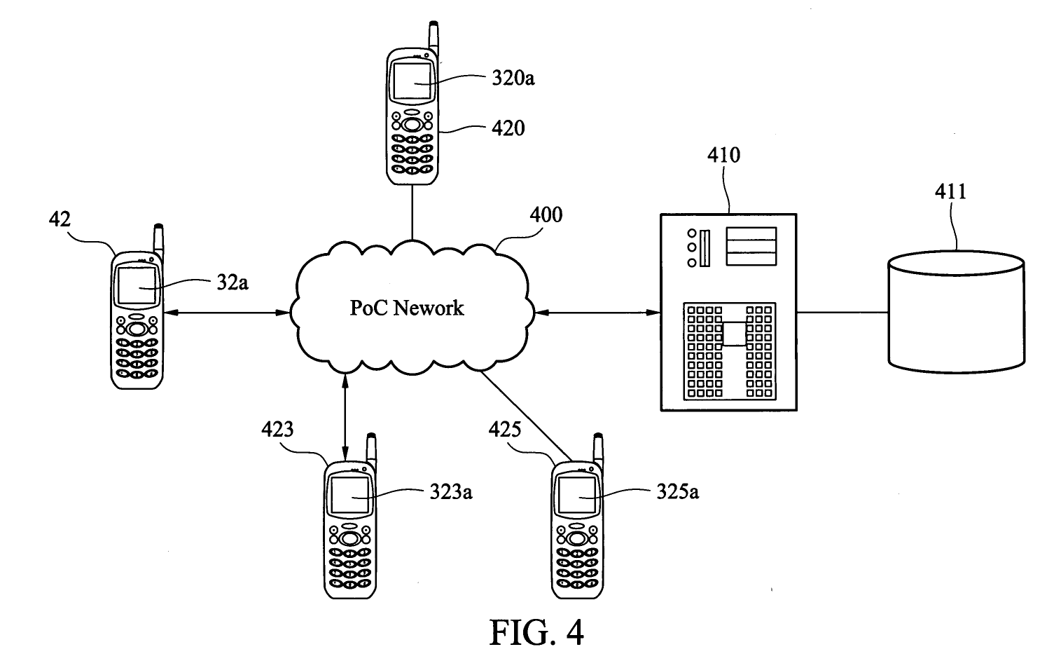

According to another embodiment, a Push to talk over cellular (PoC) service is implemented. Using FIG. 4 as an example, a communication system providing a PoC service is illustrated. The push to talk service is implemented using a Push to Talk application server (PTT server) 410 in an IP Multimedia Subsystem (IMS) frame. The PTT server 410 handles call set-up signaling for Push to Talk calls, reservation of talk spurts for one speaker at a time and real-time routing of IP packets, and carrying talk spurts to the recipients. The PTT server 410 also provides an interface to an operator system, and creates charge detail records, which can be used as a basis for billing. The Push to Talk scales to multimillion user networks with several networked Push to Talk application servers. A Push to Talk user database 411 stores data pertaining to provisioned users, their access rights, authentication information, preconfigured group membership, and contact list specifying buddy names and pertaining information predetermined by a specific user. Here, the contact list stored in Push to Talk user database 411 is referred to as a master contact list, specifying the latest presence status of a plurality of buddy names predetermined by a particular user.

PoC clients 420, 421, 423, and 425 are mobile phones supporting PoC services. PoC clients 420, 421, 423, and 425 comprise PoC buttons 420a, 421a, 423a, and 425a, respectively. PoC clients 420, 421, 423, and 425 communicate with a PTT server 410 via a PoC network 400. The PoC network 400 can be a second generation GSM/GPRS network, or other network supporting a half duplex VoIP technology. Each of the PoC clients 420, 421, 423, and 425 comprises a storage device (not shown) storing a local slave contact list duplicated from the master contact list. The local slave contact list specifies presence status of a plurality of buddy names predetermined by the user. The PoC clients 420, 421, 423, and 425 comprise processors (not shown) and screens 420, 421, 423, and 425, respectively. Each of the processors can perform a login process to PTT server 410, causes the corresponding screen to display the local slave contact list. The screen may display the local slave contact list immediately after the login process. The screen further displays an icon for each buddy name within the local slave contact list. The icon presents a first appearance in the local slave contact list. The screen also displays the new slave contact list immediately after it has been generated. When the screen displays an icon for each buddy name of the new slave contact list, the icon presents a second appearance for one of the buddy names in the new slave contact list. The processor also duplicates the master contact list to update the local slave contact list and generates a new contact list therefrom transparently. The processor can send and receive an instant message before the new contact list is generated. The instant message may comprise voice messages, thus, users can communicate in real-time.

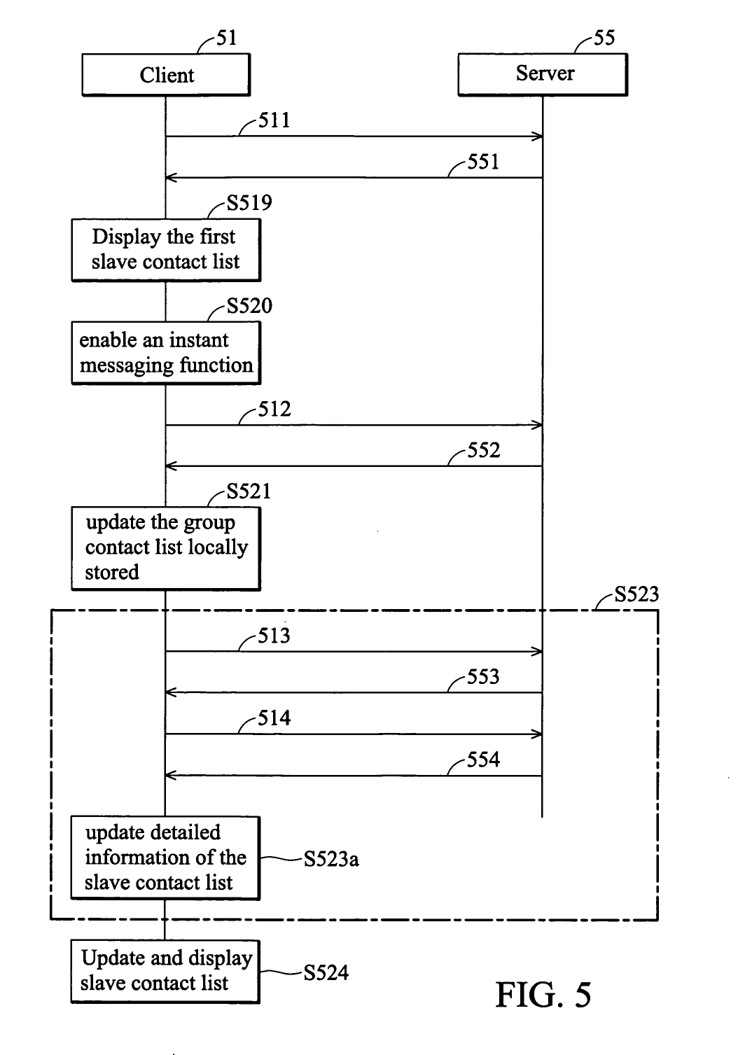

FIG. 5 shows operations of an embodiment of a method for an instant messaging application. Here, an instant messaging service using a mobile phone as a client device is illustrated as an example.

An instant message client 51 (hereinafter referred to as client 51) initiates a login procedure in conjunction with a server 55. A login request 511 is first sent from client 51 to server 55, and a login response 551 is sent from server 55 to client 51. The server 55 stores a master contact list for a user. The master contact list specifies the latest presence status of a plurality of buddy names predetermined by the user. The client 51 stores a local slave contact list duplicated from the master contact list. The local slave contact list specifies presence status of a plurality of buddy names predetermined by the user. At the time client 51 trying to login server 55, the presence status recorded in the slave contact list may be different from that in the master contact list. The master contact list comprises information specifying the latest presence status, while the slave contact list is duplicated from a previous view of the master contact list. When the presence status specified in the master contact list has changed since the slave contact list has been updated last time, the presence status specified in the slave contact list differs from that in the master contact list.

After the login process is completed, the local slave contact list is displayed in a screen of client 51 (step S519).

In step S520, an instant messaging function is enabled. When the instant messaging function is enabled, a user can send an instant message to another user corresponding to a buddy name specified in the local slave contact list.

Meanwhile, a contact list updating step is performed simultaneously and transparently. When updating the contact list, a selected part of the master contact list can be retrieved and the corresponding part of the locally stored contact list is updated accordingly. The selected part can be determined by a user. A (group) contact list request 512 is sent from client 51 to server 55, and a (group) contact list response 552 is sent from server 55 to client 51.

In step S521, the group contact list locally stored in client 51 is updated.

In step S523, detailed information of the slave contact list is updated. A request 513 for detailed information of each group is sent from client 51 to server 55, and detailed information of each group 553 is sent from server 55 to client 51.

A request 514 for detailed information of each contact buddy name is sent from client 51 to server 55, and detailed information of each buddy name 554 is sent from server 55 to client 51. When detailed information corresponding to a particular group is retrieved, the slave contact list is updated, and the updated part of the slave contact list is displayed (step S523a). Here, an icon is displayed for each buddy name within the local slave contact list. The icon presents different appearances of a buddy name corresponding to old and updated presence information.

Additionally, when performing the step of updating the local slave contact list, the master contact list can be duplicated and retrieved, the duplicated master contact list is en compared with the local slave contact list. When the contents of the local slave contact list and the duplicated master contact list are different, the local slave contact list is updated according to the duplicated master contact list. When the contents of the local slave contact list and the duplicated master contact list are the same, the contents of the local slave contact list do not have to be rewritten.

When a user has been connected to the server, the server notifies corresponding clients to update the presence status of the user. For example, during the contact list updating process, a user A, which has been added to the contact list of client 51, is connected to server 55. Server 55 notifies client 51 of the new presence status of user A. In this case, the new presence status of user A is updated corresponding to the notification even if the updating process has not yet updated the presence status of the buddy name A corresponding to user A. When the updating process comes to the buddy name A, it is first determined whether the presence status of the buddy name A in the slave contact list has been updated, and if so, the updating process proceeds to next buddy name, otherwise, the presence status of the buddy name A is updated according to the master contact list.

Additionally, when a user wants to change the slave contact list, the master contact, instead of the slave contact list, is changed first, and the slave contact list is then changed accordingly. For example, when a new buddy name is to be added, the new buddy name is first added to the master contact list, and the slave contact list is updated accordingly. When one of the buddy names is to be deleted, the buddy name is first deleted from the master contact list, and the slave contact list is updated accordingly.

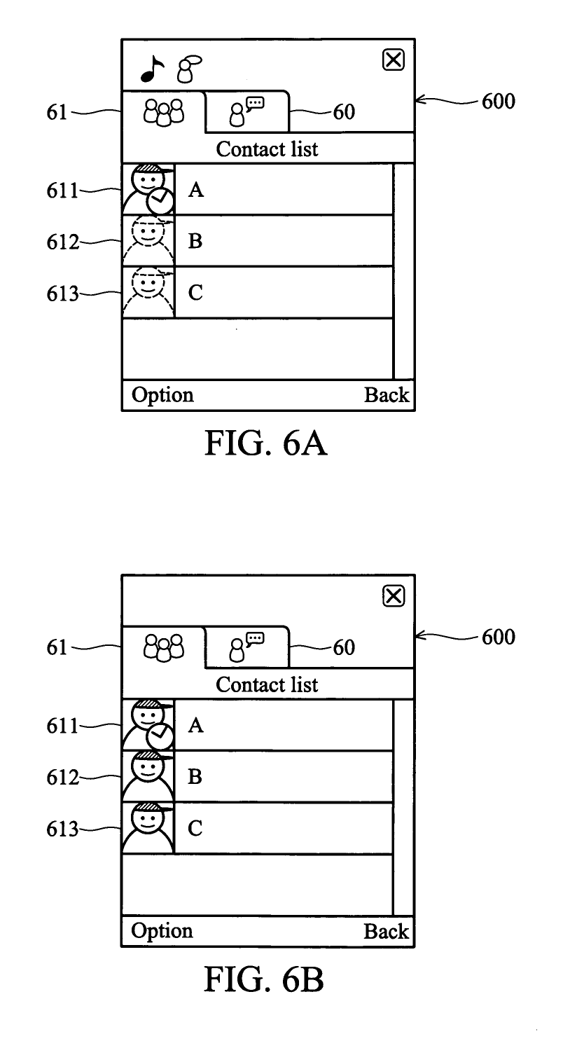

Referring to FIGS. 6A and 6B, an embodiment of a contact list displayed on a screen of client device is illustrated. Using FIG. 6A as an example, screen 600 comprises a contact list page 61 and message page 60. When the contact list page 61 is displayed, a locally stored contact list is presented. When the message page 60 is selected, an instant message application can be utilized. Here, buddy names A, B, and C correspond to icons 611, 612, and 613. Here, each icon comprises a portrait predetermined by the user. For an icon representing a buddy name corresponding to updated presence status, the portrait is clear. For an icon representing a buddy name corresponding to un-updated presence status, the icon is blurred. For example, icon 611 in FIG. 6A is clear, while icons 612 and 613 are blurred. Step 523 can be repeated according to direction of the user. Each time step S523 is performed, the presence status of a selection, such as a buddy group, is retrieved from the server 55 and the corresponding part of the contact list stored in client 51 is updated.

In step S524, the slave contact list is synchronized according to the retrieved master contact list. The synchronized contact list can be illustrated as in FIG. 6B. For example, icons 611, 612 and 613 are clear in FIG. 6B.

While the invention has been described by way of example and in terms of several embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An instant messaging system, comprising:
a server, providing an instant messaging service, storing a master contact list; and
a client device, utilizing the instant messaging service, comprising:
a storage device, for storing an local slave contact list; and
a processor, performing a login process to the server; retrieving the local slave contact list from the storage device, wherein the local slave contact list includes at least one name; enabling the instant message service right after the login process; and after the instant message service is enabled, updating initialization information corresponding to each name listed in the local slave contact list transparently according to the master contact list stored in the server.

2. The instant messaging system of claim 1, wherein the client device further comprises:
an interface for displaying the local slave contact list right after the login process.

3. The instant messaging system of claim 2, wherein the local slave contact list further comprises at least an icon corresponding to each name, the interface further displays the icon corresponding to the name in the local slave contact list whose initialization information has been updated in a first appearance, and displaying the icon corresponding to the item in the local slave contact list whose initialization information has not been updated in a second appearance.

4. The instant messaging system of claim 2, wherein the interface further displays the updated local slave contact list.

5. The instant messaging system of claim 1, wherein the processor sends and/or receives an instant message before the local slave contact list is updated.

6. The instant messaging system of claim 1, wherein the processor further performs the steps of:
duplicating the master contact list from the server;
comparing the duplicated master contact list with the local slave contact list; and
updating the local slave contact list according to the duplicated master contact list when the local slave contact list and the duplicated master contact list are different.

7. A device utilizing an instant messaging service provided by a server, comprising:
a storage device storing a local slave contact list; and
a processor, performing a login process to the server; retrieving the local slave contact list from the local storage device, wherein the local slave contact list includes at least one name; enabling the instant message service right after the login process; and after the instant message service is enabled, updating initialization information corresponding to each name listed in the local slave contact list transparently according to a master contact list stored in the server.

8. The device of claim 7, further comprising:
an interface for displaying the local slave contact list right after the login process.

9. The device of claim 8, wherein the local slave contact list further comprises at least an icon corresponding to each name, the interface further displays the icon corresponding to the name in the local slave contact list whose initialization information has been updated in a first appearance, and displaying the icon corresponding to the item in the local slave contact list whose initialization information has not been updated in a second appearance.

10. The device of claim 8, wherein the interface further displays the updated local slave contact list.

11. The device of claim 7, wherein the processor sends and/or receives an instant message before the local slave contact list is updated.

12. The device of claim 7, wherein the processor further performs the steps of:
duplicating the master contact list from the server;
comparing the duplicated master contact list with the local slave contact list; and
updating the local slave contact list according to the duplicated master contact list when the local slave contact list and the duplicated master contact list are different.

13. A method for utilizing an instant messaging service provided by a server, comprising:
performing a login process to the server;
retrieving a local slave contact list stored in a local storage device, wherein the local slave contact list includes at least one name;
enabling the instant message service right after the login process; and
after the instant message service is enabled, updating initialization information corresponding to each name listed in the local slave contact list transparently according to a master contact list stored in the server.

14. The method of claim 13, further comprising:
displaying the local slave contact list right after the login process.

15. The method of claim 13, wherein the local slave contact list further comprises at least an icon corresponding to each name, the method further comprising:
displaying the icon corresponding to the name in the local slave contact list whose initialization information has been updated in a first appearance, and displaying the icon corresponding to the item in the local slave contact list whose initialization information has not been updated in a second appearance.

16. The method of claim 13, further comprising:
displaying the updated local slave contact list.

17. The method of claim 13, further comprising:
sending and/or receiving an instant message before the local slave contact list is updated.

18. The method of claim 13, wherein the step of updating the local slave contact list further comprises:
duplicating the master contact list from the server;
comparing the duplicated master contact list with the local slave contact list; and
updating the local slave contact list according to the duplicated master contact list when the local slave contact list and the duplicated master contact list are different.
